(19) United States
(12) Patent Application Publication
(10) Pub. No.: US 2021/0189227 A1
(43) Pub. Date: Jun. 24, 2021

(54) PICKERING EMULSIONS USED IN WELLBORE SERVICING FLUIDS AND METHODS

(71) Applicant: Halliburton Energy Services, Inc., Houston, TX (US)

(72) Inventors: Monica Rajendra Dandawate, Pune (IN); Anupom Sabhapondit, Al Khobar (SA); Sairam Eluru, Pune (IN); Salla Rajender, Pune (IN)

(21) Appl. No.: 16/074,345

(22) PCT Filed: Apr. 7, 2016
(86) PCT No.: PCT/US16/26423

§ 371 Date: Jul. 31, 2018

(51) Int. Cl. C09K 8/84; C09K 8/80; C09K 8/88; E21B 43/267

(52) U.S. Cl. CPC C09K 8/845; C09K 8/80; E21B 43/267; C09K 8/885; C09K 8/882

(57) ABSTRACT

In wellbore servicing fluids and methods related thereto a Pickering emulsion is produced by mixing silica, an oleaginous fluid, an aqueous base fluid and an emulsifier. The silica can comprise a silica dust and larger proppant particles that work together to form a Pickering emulsion with the proppant particles suspended therein. In some embodiments, the proppant particles are a silica sand.

### FIELD

This disclosure relates to methods of servicing a wellbore. More specifically, it relates to servicing a wellbore with particulate material compositions.

### BACKGROUND

Natural resources (e.g., oil or gas) residing in the subterranean formation may be recovered by driving resources from the formation into a wellbore using, for example, a pressure gradient that exists between the formation and the wellbore, the force of gravity, displacement of the resources from the formation using a pump or the force of another fluid injected into the well or an adjacent well. The production of fluid in the formation may be increased by hydraulically fracturing the formation. That is, a treatment fluid (e.g., a fracturing fluid, a gravel packing fluid, etc.) may be pumped down the wellbore at a rate and a pressure sufficient to form fractures that extend into the formation, providing additional pathways through which the oil or gas can flow to the well.

Treatment fluids used in fracturing operations generally comprise polymers and crosslinkers (e.g., a cross-linked gel system) that are used for increasing the viscosity of the fluid such that particulate materials can be suspended in the fluid. These treatment fluids may have a complex set of ingredients and may require specialized conditions, such as, for example, specific pH values and the use of pH buffering agents.

Oftentimes, after the treatment fluid has performed its intended task, it may be desirable to reduce its viscosity (e.g., “break” the fluid or gel) so that the treatment fluid can be recovered from the formation and/or particulate material may be dropped out of the treatment fluid at a desired location within the formation. Breakers can be generally employed to reduce the viscosity of treatment fluids. Unfortunately, traditional breakers may result in an incomplete and/or premature viscosity reduction. Premature viscosity reduction is undesirable as it may lead to, inter alia, particulate material settling out of the fluid in an undesirable location and/or at an undesirable time. Alternately, encapsulated breakers may be used to control the release rate of breaker. However, such option adds to material costs.

Additionally, water scarcity and supply is a big concern in using such treatment fluids for particular operations such as fracturing where millions of gallons of water can be required continuously. Due to several limitations, conventional gelling agent compositions work best or even require the use of fresh or purified water. Unfortunately, this fresh water requirement may limit the scope of operation in certain regions. Besides this, there can be the challenge of disposing of the produced water based on regional environmental regulations. Thus, an ongoing need exists for improved compositions and methods of using treatment fluids comprising particulate materials.

### BRIEF DESCRIPTION OF THE DRAWINGS

FIG. 1A is a diagram illustrating a classic emulsion.

FIG. 1B is a diagram illustrating a Pickering emulsion.

FIG. 2 is a diagram illustrating an example of a fracturing system that may be used in accordance with certain embodiments of the present disclosure.

FIG. 3 is a diagram illustrating an example of a subterranean formation in which a fracturing operation may be performed in accordance with certain embodiments of the present disclosure.

### DETAILED DESCRIPTION

The present disclosure may be understood more readily by reference to the following detailed description as well as to the examples included therein. In addition, numerous specific details are set forth in order to provide a thorough understanding of the embodiments described herein. However, those of ordinary skill in the art will understand that the embodiments described herein can be practiced without these specific details. In other instances, methods, procedures and components have not been described in detail so as not to obscure the related relevant feature being described. Also, the description is not to be considered as limiting the scope of the embodiments described herein. The figures are not necessarily to scale and the proportions of certain parts have been exaggerated to better illustrate details and features of the present disclosure.

In several applications, wellbore servicing fluids need to be viscous enough to suspend particles, such as gravel or proppant, in order to carry the proppant downhole. Generally, viscosifying agents, such as guar gum and other polymers and/or cross-linked polymers, have been utilized for this purpose. At other times, foaming has been used for this purpose. Additionally, while emulsions have been proposed to increase viscosity, emulsions have typically suffered from breaking down relatively quickly (one hour, about half an hour or even less) at relatively moderate downhole temperatures (about 250° F. or less or even 200° F. or less). The current disclosure is directed to the discovery that Pickering emulsions can be formed using silica as stabilizing particles to form an emulsion from an aqueous base fluid containing relatively low ratios of oleaginous fluids and emulsifiers. The Pickering emulsion is produced by mixing silica, an oleaginous fluid, an aqueous base fluid and an emulsifier. The emulsion does not form until the silica is added to the other components. That is, in some embodiments, the components and amounts are chosen such that a classical emulsion will not form upon mixing the aqueous base fluid, oleaginous fluid and/or emulsifier until the silica is added to thus form the Pickering emulsion. “A classical emulsion will not form” means forming an emulsion that is stable for at least 30 minutes at room temperature and atmospheric pressure. Further, a synergistic result is seen where the silica consists essentially of silica dust or powder having a particle size of less than 1000 nm and proppant particles having a particle size from about 2 to about 400 mesh, preferably the proppant is sand and more preferably a silica based sand. Such Pickering emulsions can suitably suspend proppant particles for downhole operations where the wellbore servicing fluid comprised of the Pickering emulsion is substantially free or free from gelling agents, gel precursors and weighting agents, and is not subject to foaming, that is, is not in a foamed state. In some embodiments, the wellbore servicing fluid consists essentially of one or more Pickering emulsions described herein.

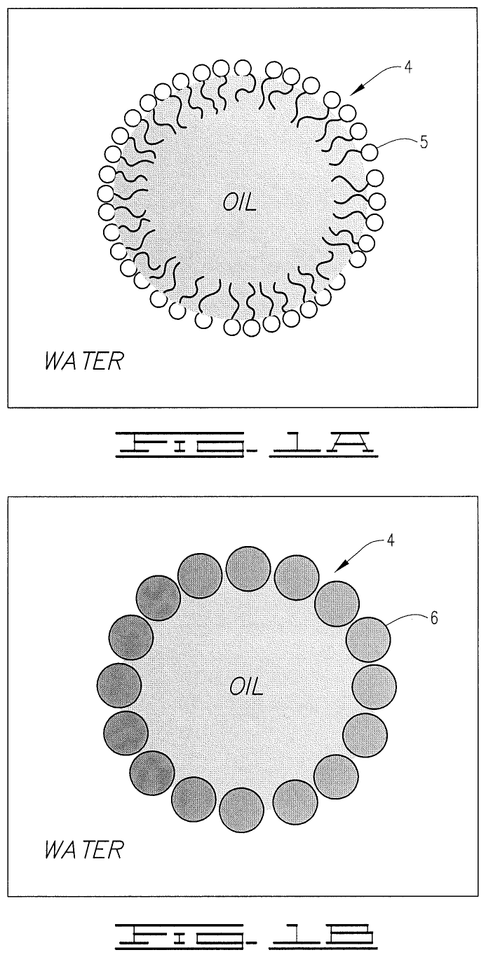

Pickering emulsions are emulsions that are stabilized by solid particles, which are absorbed onto the interface between the two phases (typically an aqueous phase and an oil phase). As illustrated in FIG. 1A, oil and water are mixed and small oil droplets 4 are formed and dispersed throughout the water to form a classic emulsion, where oil molecules 5 orient at the oil-water interface such that the more hydrophilic end of each oil molecule 5 faces the water and the more hydrophobic end faces the oil droplet. Eventually the droplets will coalesce to decrease the amount of energy; thus, the emulsion will breakdown. As illustrated in FIG. 1B, in a Pickering emulsion, solid particles 6 are added to the mixture. Solid particles 6 bind to the surface of the interface and prevent the droplets from coalescing, thus causing the emulsion to be more stable. Further, the current disclosure rest on the discovery that when small particles (less than 1000 nm) are used with large particles (1000 nm or greater), the larger particles can play a role in emulsion formation and stabilization, especially when silica based sand is used as the source of the large and small particles.

As indicated above, the silica comprises a silica dust or powder comprising particles having a particles size of less than 1000 nm. Generally, the silica can comprise or consist essentially of silica dust having a particle size of less than about 750 nm or less than about 500 nm. However, to take full advantage of the invention, the silica will more typically comprise such a silica dust with proppant particles having a size greater than 1000 nm. Generally, the proppant can have an average particle size of from about 2 to about 400 mesh, about 4 to about 200 mesh, or about 8 to about 140 mesh. While the proppant particles can be selected from any suitable proppants or combinations thereof, generally the proppant particles will be sand or ceramic materials, as bauxite based ceramics. Sand, and especially silica based sand, has been found to be particularly useful in forming a suitable Pickering emulsion. In many applications, the silica will consist essentially of the silica dust and the proppant particles. In some cases, the silica will consist essentially of silica dust, proppant particles and intermediate particles, where the intermediate particles are particles whose size is between the silica dust and proppant particles. Preferably, any intermediate particles are silica particles. Often the silica dust can be from about 0.1 wt. % to about 2 wt. %, from about 0.2 wt. % to about 1.5 wt. %, or from about 0.5 wt. % to about 1 wt. % based on the total silica. The proppant particles can be present from about 90 wt. % to about 99.9 wt. %, from about 95 wt. % to about 99.8 wt. %, or from about 98 wt. % to about 99.9 wt. % based on the total silica. In combinations where the above amounts of silica do not reach 100 wt %, the balance of the silica is intermediate particles.

Aqueous base fluids that may be used in the Pickering emulsions and wellbore service fluids described herein include any aqueous fluid suitable for use in subterranean applications. For example, the aqueous base fluid may be fresh water or various types of salt water, such as seawater, brine or produced water. It has been found that the stability of the resulting Pickering emulsions is greater with salt water; therefore, in some embodiments the aqueous base fluid is selected from the group comprising seawater, brine, produced water and combinations thereof. Generally, the salt water used will be one comprised of water, an inorganic monovalent salt, an inorganic multivalent salt, or both.

Nonlimiting examples of salts suitable for forming the saltwater include chloride-based, bromide-based, phosphate-based or formate-based salts of alkali and alkaline earth metals, or combinations thereof. Additional examples of suitable salts include, but are not limited to, NaCl, KCl, NaBr, CaCl₂, CaBr₂, ZnBr₂, ammonium chloride (NH₄Cl), potassium phosphate, sodium formate, potassium formate, cesium formate, ethyl formate, methyl formate, methyl chloro formate, triethyl orthoformate, trimethyl orthoformate, or combinations thereof. Typical embodiments can use salt water formed primarily from NaCl.

Nonlimiting examples of oleaginous fluids suitable for use in the present disclosure include petroleum oils, natural oils, synthetically-derived oils, diesel oil, fuel oil, kerosene oil, mixtures of crude oil, mineral oil, synthetic oil, vegetable oils, olefins, polyolefins, alpha-olefins, internal olefins, polydiorganosiloxanes, acetals, esters, diesters of carbonic acid, linear or branched paraffins, or combinations thereof.

The emulsifier can be any suitable emulsifier. Typically, the emulsifier is one or more emulsifiers selected from polyolefin amides, alkeneamides, reaction product of fatty acid, tall oil with diethylenetriamine, maleic anhydride, tetraethylenepentamine, triethylenetretramine, oil wetting nonionic surfactant emulsifier, combination of emulsifiers where, the primary emulsifier can be, for example, a blend of fatty acids or any surfactant which provides the primary emulsion stability while the secondary emulsifier can provide additional emulsion stabilization and oil wetting properties with a blend of surfactants or blend of surfactant emulsifier forming invert emulsion with a wetting agent. In some cases, the emulsifier is selected from the group consisting of polyolefin amides, alkeneamides, reaction product of fatty acid, tall oil with diethylenetriamine, maleic anhydride, tetraethylenepentamine, triethylenetretramine, and combinations thereof.

To effectively achieve the Pickering emulsion, it is generally preferable that the ratio of oleaginous fluid to water be at least 1:7. Typically, the ratio is greater (more water to oleaginous fluid), such as about 1:10 or, more typically, about 1:20. In such emulsions, the emulsifier will generally be present in ratio of oleaginous fluid to emulsifier of approximately 1:0.2, more generally from about 1:0.1 to about 1:0.4. Accordingly, examples of typical ratios of oleaginous fluid to water to emulsifier are 1:10:0.2, 1:20:0.2 and ratios in between. To achieve suitable ratios, the oleaginous fluid is generally present in the Pickering emulsion in a volume that is less than 15% of the volume of the aqueous base fluid. More typically, the oleaginous fluid is present in the Pickering emulsion in a volume from about 1% to about 15% of the volume of the aqueous base fluid, from about 2% to about 12% of the volume of the aqueous base fluid, from about 3% to about 7% of the volume of the aqueous base fluid or less than 7% of the volume of the aqueous base fluid, and the oleaginous fluid can be present at less than 5% or at about 5% of the volume of the aqueous base fluid. Additionally, the emulsifier is typically present in the Pickering emulsion in a volume of 1% or less of the volume of the aqueous base fluid. More generally, the emulsifier is present in the Pickering emulsion in a volume that is from about 0.05% to about 4%, about 0.1% to about 1.5%, or about 0.2% to about 2% of the volume of the aqueous base fluid. In some embodiments, the emulsifier is present in the Pickering emulsion in a volume that is from about 0.2% to about 1.0% of the volume of the aqueous base fluid, from about 0.5% to less than 1.0% of the volume of the aqueous base fluid, or is less than 1% of the volume of the aqueous base fluid.

The silica can be included in the Pickering emulsion in an amount from about 1 pounds per gallon (ppg) to about 30 ppg based on the total volume of the Pickering emulsion. Alternatively, the silica can be included in an amount from about 2 ppg to about 20 ppg, or from about 3 ppg to about 10 ppg, based on the total volume of the Pickering emulsion.

The resulting Pickering emulsions formed in accordance with this disclosure highly stable and thus can withstand pressures of over 300 psi and temperatures of over 200° F. for over 4 hours without the emulsion breaking down or proppant settling out of the emulsion. Moreover, the Pickering emulsions can withstand pressures over 400 psi and temperatures of 250° and greater for over 4 hours without the emulsion breaking down or proppant settling out of the emulsion. Additionally, some embodiments can withstand pressures of 500 psi or more and temperatures of 300° F. or more for over 2 hours without the emulsion breaking down or proppant settling out of the emulsion.

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a mixing apparatus 20, a fluid source 30, a silica and/or proppant source 40, and a pump and blender system 50 and resides at the surface at a well site where a well 60 is located. In certain instances, the mixing apparatus 20 combines an aqueous fluid and/or an oleaginous fluid from fluid source 30, which is then introduced to pump and blender system 50. In other instances, the mixing apparatus 20 can be omitted, and the aqueous fluid and oleaginous fluid sourced directly from the fluid source 30 to pump and blender system 50.

The system may also include additive source 70 that provides an emulsifier and one or more other additives to alter the properties of the wellbore servicing fluid or, in this instance, the fracturing fluid; however, it is an advantage of the current compositions that additives such as gelling agents, gel precursers and weighting agents are not needed. Other additives that can be included are additives to reduce pumping friction, to reduce or eliminate the fluid's reaction to the geological formation in which the well is formed, to operate as surfactants, and/or to serve other functions as long as such additives do not adversely affect the Pickering emulsion.

The pump and blender system 50 receives the aqueous fluid and oleaginous fluid and combines them with other components, including silica dust and proppant from the proppant source 40 and/or additional fluid from the additives 70. The resulting mixture forms a Pickering emulsion only when the silica dust and proppant are added to the other components. That is, the components can be added in any order but, if the emulsifier, aqueous fluid and oleaginous fluid are mixed together prior to introduction of the silica dust and proppant, then the Pickering emulsion will not form until after the introduction of the silica dust and proppant. While it is possible to form the Pickering emulsion using only the silica, without the proppant, the proppant also plays a role of in the emulsion formation and, specifically the use of silica-sand proppant will produce an emulsion that can better suspend the proppant than the use of silica dust alone.

The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 to source from one, some or all of the different sources at a given time, and may facilitate the preparation of fracturing fluids in accordance with the present disclosure using continuous mixing or “on-the-fly” methods.

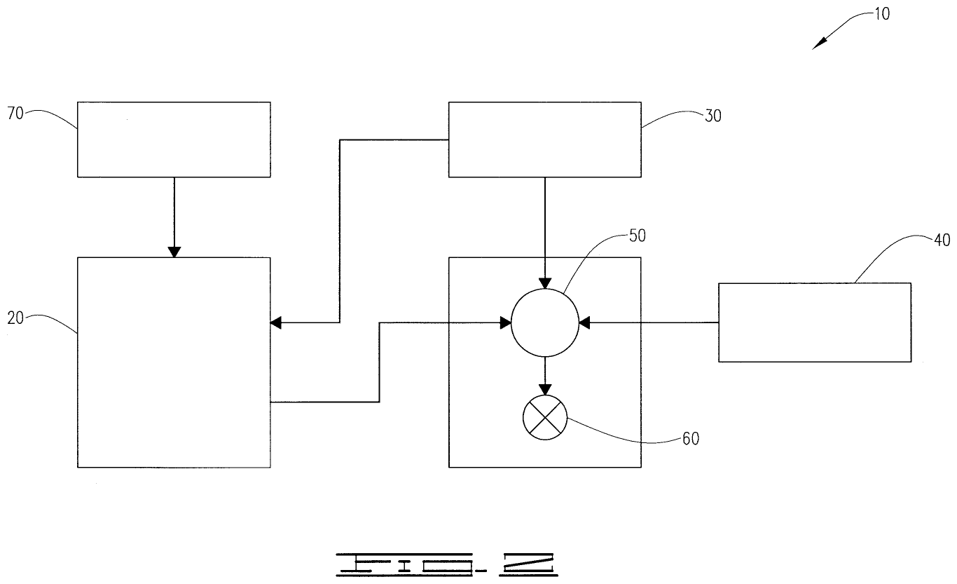

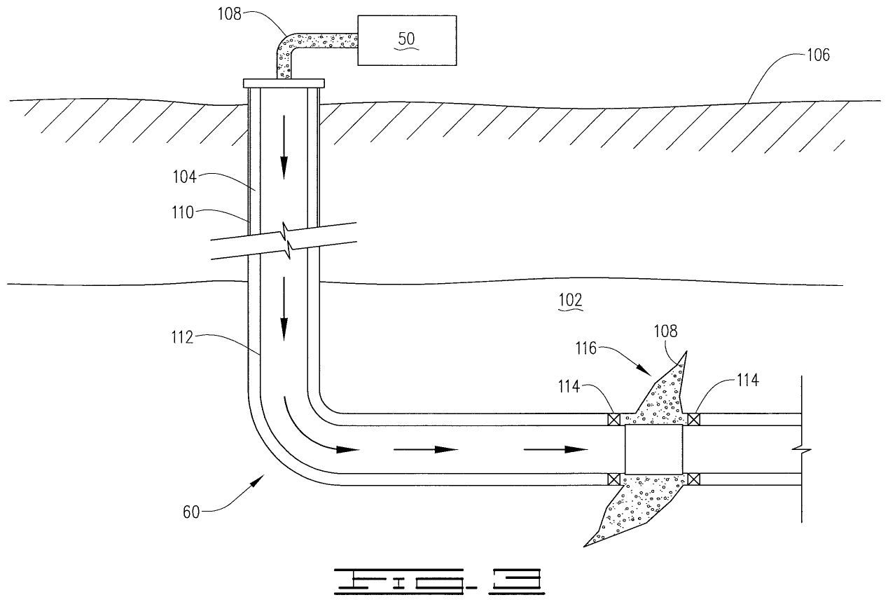

FIG. 2 shows the well 60 during a fracturing operation in a portion of a subterranean formation of interest 102 surrounding a wellbore 104. The wellbore 104 extends from the surface 106, and the fracturing fluid 108 is applied to a portion of the subterranean formation 102 surrounding the horizontal portion of the wellbore. Although shown as vertical deviating to horizontal, the wellbore 104 may include horizontal, vertical, slant, curved, and other types of wellbore geometries and orientations, and the fracturing treatment may be applied to a subterranean zone surrounding any portion of the wellbore. The wellbore 104 can include a casing 110 that is cemented or otherwise secured to the wellbore wall. The wellbore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro jetting and/or other tools.

The well is shown with a work string 112 depending from the surface 106 into the wellbore 104. The pump and blender system 50 is coupled with a work string 112 to pump the fracturing fluid 108 into the wellbore 104. The working string 112 may include coiled tubing, jointed pipe, and/or other structures that allow fluid to flow into the wellbore 104. The working string 112 can include flow control devices, bypass valves, ports, and or other tools or well devices that control a flow of fluid from the interior of the working string 112 into the subterranean zone 102. For example, the working string 112 may include ports adjacent the wellbore wall to communicate the fracturing fluid 108 directly into the subterranean formation 102, and/or the working string 112 may include ports that are spaced apart from the wellbore wall to communicate the fracturing fluid 108 into an annulus in the wellbore between the working string 112 and the wellbore wall.

The working string 112 and/or the wellbore 104 may include one or more sets of packers 114 that seal the annulus between the working string 112 and wellbore 104 to define an interval of the wellbore 104 into which the fracturing fluid 108 will be pumped. FIG. 2 shows two packers 114, one defining an uphole boundary of the interval and one defining the downhole end of the interval. When the fracturing fluid 108 is introduced into wellbore 104 (e.g., in FIG. 2, the area of the wellbore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the wellbore. Generally, after the proppant particles have entered the fracture, the Pickering Emulsion is allowed to breakdown and the aqueous base fluid and oleaginous fluid flow up the wellbore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

### EXAMPLES

Having generally described the embodiments, the following examples are given as particular embodiments of the disclosure and to demonstrate the practice and advantages thereof. It is understood that the examples are given by way of illustration and are not intended to limit the specification of the claims in any manner.

### Example 1

To 75 mL of Angola Sea water in a beaker, 7.5 mL of oil (LCA-1) was added followed by addition of 1.5 mL of an emulsifier. The emulsifier used was BROMI-MUL™ emulsifier available from Halliburton Energy Services, Inc. The fluid was placed under over stirrer and stirred at 1000 rpm while 59 g of Brady sand (6 ppg) was added to the fluid. The oil, water and emulsifier ratio was approximately 1:10:0.2; however, the emulsifier ratio was slightly lower because the emulsifier included an oil wetting agent.

The emulsion was not formed when fluid was stirred without the sand. However, an emulsion formed after the addition of sand to the fluid. It was also observed that the emulsion formed independent of the order of addition of sand to the fluid. The Brady sand included sand dust (silica dust) and larger proppant particles.

A proppant settlement test was conducted by placing the emulsion in an autoclave at 250° F. under 500 psi. No settlement was observed until 4.0 hours.

### Example 2

A Pickering Emulsion was prepared following the same procedure as Example 1, except produced water was used instead of seawater. The ratio of oil, water and emulsifier in the Pickering Emulsion was approximately 1:10:0.2.

A proppant settlement test was conducted by placing the emulsion in an autoclave at 250° F. under 500 psi. No settlement was observed until 4.0 hours.

### Example 3

A Pickering Emulsion was prepared following the same procedure as Example 1, except fresh water was used instead of seawater and the emulsifier used was EZ-MUL™ emulsifier available from Halliburton Energy Services, Inc. The ratio of oil, water and emulsifier in the Pickering Emulsion was approximately 1:20:0.2.

A proppant settlement test was conducted by placing the emulsion in an autoclave at 250° F. under 500 psi. No settlement was observed for at least 4.0 hours.

Several alternative embodiments will now be set forth to further define the invention. In one group of embodiments, a wellbore servicing fluid comprises a Pickering emulsion. The Pickering emulsion is produced by mixing silica, an oleaginous fluid, an aqueous base fluid and an emulsifier. In some embodiments, the wellbore servicing fluid will be substantially free or free from gelling agents, gel precursers and weighting agents. In other embodiments, the wellbore servicing fluid consists essentially of the Pickering emulsion.

In another group of embodiments, a method of servicing a wellbore in a subterranean formation is provided. The method comprises providing a wellbore servicing fluid by mixing silica, an aqueous base fluid, an oleaginous fluid and an emulsifier to form a Pickering emulsion; and introducing the wellbore servicing fluid into the wellbore. Further, an emulsion (either classical emulsion or Pickering emulsion) is not formed until after the silica is mixed with the aqueous base fluid, the oleaginous fluid and the emulsifier. The method can further comprise allowing the emulsion to breakdown after introduction into the wellbore wherein the breakdown occurs at least 4 hours after the wellbore servicing fluid reaches the subterranean formation. In some of these embodiments, the step of providing the wellbore servicing fluid comprises mixing using mixing equipment. Additionally or alternatively, the wellbore servicing fluid can be introduced into the wellbore using one or more pumps.

The oleaginous fluid of all the above embodiments is generally present in the Pickering emulsion in a volume that is less than 15% of the volume of the aqueous base fluid. More typically, the oleaginous fluid is present in the Pickering emulsion in a volume from about 1% to about 15% of the volume of the aqueous base fluid, from about 2% to about 12% of the volume of the aqueous base fluid, from about 3% to about 7% of the volume of the aqueous base fluid or less than 7% of the volume of the aqueous base fluid.

In all the embodiments, the oleaginous fluid can be selected from the group consisting of petroleum oils, natural oils, synthetically-derived oils, diesel oil, fuel oil, kerosene oil, mixtures of crude oil, mineral oil, synthetic oil, vegetable oils, olefins, polyolefins, alpha-olefins, internal olefins, polydiorganosiloxanes, acetals, esters, diesters of carbonic acid, linear or branched paraffins, or combinations thereof.

The emulsifier of all the above embodiments is typically present in the Pickering emulsion in a volume of 1% or less of the volume of the aqueous base fluid. More generally, the emulsifier is present in the Pickering emulsion in a volume that is from about 0.1% to about 1.5% of the volume of the aqueous base fluid. In some embodiments, the emulsifier is present in the Pickering emulsion in a volume that is from about 0.2% to about 1.0% of the volume of the aqueous base fluid, from about 0.5% to less than 1.0% of the volume of the aqueous base fluid, or is less than 1% of the volume of the aqueous base fluid.

In all the embodiments, the emulsifier can be one or more emulsifiers selected from polyolefin amides, alkeneamides, reaction product of fatty acid, tall oil with diethylenetriamine, maleic anhydride, tetraethylenepentamine, triethylenetretramine, oil wetting nonionic surfactant emulsifier, combination of emulsifiers where, the primary emulsifier can be, for example, a blend of fatty acids or any surfactant which provides the primary emulsion stability while the secondary emulsifier can provide additional emulsion stabilization and oil wetting properties with a blend of surfactants or blend of surfactant emulsifier forming invert emulsion with a wetting agent. In some cases, the emulsifier is selected from the group consisting of polyolefin amides, alkeneamides, reaction product of fatty acid, tall oil with diethylenetriamine, maleic anhydride, tetraethylenepentamine, triethylenetretramine, and combinations thereof.

In all the embodiments, the silica can consist essentially of silica dust having a particle size of less than about 1000 nm. In some cases, the silica can consist essentially of silica dust having a particle size of less than about 750 nm or less than about 500 nm. In these embodiments, the wellbore servicing fluid can further comprise a proppant having an average particle size of from about 2 to about 400 mesh, about 4 to about 200 mesh, or about 8 to about 140 mesh. Typically, the proppant is sand. Generally, in the method described above, the proppant will be added with the silica and together the silica and sand will initiate the formation of the Pickering emulsion during mixing. However, in other embodiments, the silica consists essentially of silica dust having a particle size of less than about 1000 nm, about 750 nm or about 500 nm and a proppant having an average particle size of from about 2 to about 400 mesh, about 4 to about 200 mesh, or about 8 to about 180 mesh. In these embodiments, the proppant is preferably sand.

Therefore, the present invention is well adapted to attain the ends and advantages mentioned as well as those that are inherent therein. The particular embodiments disclosed herein are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a to b”) disclosed herein is to be understood to set forth every number and range encompassed within the broader range of values. Additionally, where the term “about” is used in relation to a range it generally means plus or minus half the last significant figure of the range value, unless context indicates another definition of “about” applies.

Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A wellbore servicing fluid comprising:
a Pickering emulsion produced by mixing silica, an oleaginous fluid, an aqueous base fluid and an emulsifier.

2. The wellbore servicing fluid of claim 1, wherein the oleaginous fluid is present in the Pickering emulsion in a volume that is from about 2% to about 12% of the volume of the aqueous base fluid.

3. The wellbore servicing fluid of claim 1, wherein the emulsifier is present in the Pickering emulsion in a volume that is from about 0.1% to about 1.5% of the volume of the aqueous base fluid.

4. The wellbore servicing fluid of claim 1, wherein the emulsifier is present in the Pickering emulsion in a volume that is less than 1% of the volume of the aqueous base fluid.

5. The wellbore servicing fluid of claim 1, wherein the oleaginous fluid is selected from the group consisting of petroleum oils, natural oils, synthetically-derived oils, diesel oil, fuel oil, kerosene oil, mixtures of crude oil, mineral oil, synthetic oil, vegetable oils, olefins, polyolefins, alpha-olefins, internal olefins, polydiorganosiloxanes, acetals, esters, diesters of carbonic acid, linear or branched paraffins, or combinations thereof.

6. The wellbore servicing fluid of claim 1, wherein the emulsifier is selected from the group consisting of polyolefin amides, alkeneamides, reaction product of fatty acid, tall oil with diethylenetriamine, maleic anhydride, tetraethylenepentamine, triethylenetretramine, and combinations thereof.

7. The wellbore servicing fluid of claim 1, wherein the silica consists essentially of silica dust having a particle size of less than about 1000 nm.

8. The wellbore servicing fluid of claim 7, further comprising a proppant having an average particle size of from about 2 to about 400 mesh.

9. The wellbore servicing fluid of claim 8, wherein the proppant is silica-sand.

10. The wellbore servicing fluid of claim 9, wherein:
the wellbore servicing fluid consists essentially of the Pickering Emulsion produced by mixing silica dust, silica-sand, the oleaginous fluid, the aqueous base fluid and the emulsifier;
the oleaginous fluid is present in the Pickering emulsion in a volume that is from about 3% to about 7% of the volume of the aqueous base fluid;
the emulsifier is present in the Pickering emulsion in a volume that is from about 0.5% to less than 1.0% of the volume of the aqueous base fluid; and
the oleaginous fluid is selected from the group consisting of petroleum oils, natural oils, synthetically-derived oils, diesel oil, fuel oil, kerosene oil, mixtures of crude oil, mineral oil, synthetic oil, vegetable oils, olefins, polyolefins, alpha-olefins, internal olefins, polydiorganosiloxanes, acetals, esters, diesters of carbonic acid, linear or branched paraffins, or combinations thereof.

11. A method of servicing a wellbore in a subterranean formation comprising:
providing a wellbore servicing fluid by mixing silica, an aqueous base fluid, an oleaginous fluid and an emulsifier to form a Pickering emulsion, wherein an emulsion is not formed by the components until the silica is mixed with the oleaginous fluid, the aqueous base fluid and the emulsifier; and
introducing the wellbore servicing fluid into the wellbore.

12. The method of claim 11, wherein the oleaginous fluid is present in the Pickering emulsion in a volume that is from about 2% to about 12% of the volume of the aqueous base fluid.

13. The method of claim 11, wherein the emulsifier is present in the Pickering emulsion in a volume that is from about 0.1% to about 1.5% of the volume of the aqueous base fluid.

14. The method of claim 11, wherein the emulsifier is present in the Pickering emulsion in a volume that is less than 1% of the volume of the aqueous base fluid.

15. The method of claim 11, wherein the oleaginous fluid is selected from the group consisting of petroleum oils, natural oils, synthetically-derived oils, diesel oil, fuel oil, kerosene oil, mixtures of crude oil, mineral oil, synthetic oil, vegetable oils, olefins, polyolefins, alpha-olefins, internal olefins, polydiorganosiloxanes, acetals, esters, diesters of carbonic acid, linear or branched paraffins, or combinations thereof.

16. The method of claim 11, wherein the emulsifier is selected from the group consisting of polyolefin amides, alkeneamides, reaction product of fatty acid, tall oil with diethylenetriamine, maleic anhydride, tetraethylenepentamine, triethylenetretramine, and combinations thereof.

17. The method of claim 11, wherein the wellbore servicing fluid is introduced into the wellbore using one or more pumps.

18. The method of claim 11, wherein the silica consists essentially of silica dust having a particle size of less than about 1000 nm.

19. The method of claim 18, further comprising a proppant having an average particle size of from about 2 to about 400 mesh.

20. The method of claim 19, wherein the proppant is sand, in the step of providing the Pickering emulsion, the proppant and sand are added together to the aqueous base fluid, oleaginous fluid and emulsifier, and the proppant and sand instigate the formation of the Pickering emulsion.
